(19) United States
(12) Patent Application Publication
(10) Pub. No.: US 2023/0337571 A1
(43) Pub. Date: Oct. 26, 2023

(54) REAL-TIME FERTILIZATION AND/OR CROP PROTECTION DECISION MAKING BASED ON SOIL-, CROP, FIELD- AND WEATHER-RELATED DATA WHEREIN THE SOIL-RELATED DATA ARE OBTAINED BY A SOIL SENSOR

(71) Applicants: BASF AGRO TRADEMARKS GMBH, Ludwigshafen am Rhein (DE); TRINAMIX GMBH, Ludwigshafen am Rhein (DE)

(72) Inventors: Robert LOVRINCIC, Ludwigshafen am Rhein (DE); Ahmed Karim DHAOUADI, Koeln (DE); Ole JANSSEN, Dormagen (DE); Bjoern KIEPE, Köln (DE); Mollie Jo HOSS-KUHNE, Köln (DE)

(21) Appl. No.: 18/026,549

(22) PCT Filed: Sep. 30, 2021
(86) PCT No.: PCT/EP2021/077014

§ 371 Date: Mar. 15, 2023

(30) Foreign Application Priority Data
Sep. 30, 2020 (EP) 20199386.2

(51) Int. Cl. A01B 79/02; A01B 79/00

(52) U.S. Cl. CPC A01B 79/02; A01B 79/005

(57) ABSTRACT

A computer-implemented method for controlling an agricultural treatment device (200) in an agricultural field, the method comprising the following steps: (a) receiving by the computing unit (120) soil-related data relating to the sub-field zone (G1), wherein the soil-related data are obtained by real-time measurements using a soil sensor (110) and wherein (G1) which is located within the agricultural field, (b) receiving by the computing unit (120)—from a database (130) and/or from real-time measurements—crop-related data, field-related data, and weather-related data relating to the sub-field zone (G1), (c) determining via a computing unit (120)—based on the soil-related data, crop-related data, field-related data and optionally weather-related data—at least one indicator indicative of the crop protection demand and/or crop nutrition demand relating to the sub-field zone (G1), (d) dynamically generating via the computing unit (120), an output signal (140) dependent from the determined at least one indicator, wherein the output signal (140) is generated during real-time operation of the agricultural treatment device (200) and is usable for controlling the agricultural treatment device (200) at the sub-field zone (G1).

The present invention relates to a computer-implemented method for controlling an agricultural treatment device in an agricultural field and an agricultural treatment device for the treatment of an agricultural field.

### BACKGROUND OF THE INVENTION

The general background of this invention is the treatment of an agricultural field. This treatment comprises seeding—i.e. spreading of the seeds of the crops to be cultivated—, the treatment of the actual crops to be cultivated, the treatment of weed in the agricultural field, the treatment of the insects or other animal pests in the agricultural field, the treatment of pathogens in the agricultural field, the irrigation and the fertilization of the agricultural field.

Agricultural machines or automated treatment devices, like smart sprayers, treat the weed, the insects and/or the pathogens in the agricultural field based on ecological and economical rules.

Modern agricultural machines get equipped with more and more sensors, measuring or determining different parameters relevant for the treatment of an agricultural field. Important parameters in this context are the soil condition and other soil-related parameters. The soil condition characterized for example by moisture and nutrient content is key for plant growth and health and has a crucial impact on the treatment parameters (e.g. treatment type and fertilizer dosage). In the state of the art, the soil condition is either measured via a limited number of point measurements where data collection and analytics is time-consuming and costly, or the soil condition is determined via estimations based on physical models, e.g. based on remote sensing information. Both methods lack the required accuracy for digital farming applications. Other methods in the prior art solutions don't perform real-time decision making, thus require multiple field visits which are time-consuming.

### SUMMARY OF THE INVENTION

It would be advantageous to have an improved method for the treatment of an agricultural field which provides a high-quality real-time measurement and determination of the soil condition and/or other soil-related parameters and at the same time a real-time decision and/or execution regarding the treatment of an agricultural field. Furthermore, it would be advantageous to have an improved method which allows for a precise, zone-specific and soil-parameter-dependent treatment of an agricultural field. Furthermore, it would be advantageous to have a cost-efficient method which allows for a precise, zone-specific and soil-parameter-dependent where there is no need to drag sensors through the soil.

The object of the present invention is solved with the subject matter of the independent claims, wherein further embodiments are incorporated in the dependent claims. It should be noted that the following described aspects and examples of the invention apply for the method as well as for the treatment device.

In view of the above object(s) of the present invention, the present invention relates to a computer-implemented method for treatment of an agricultural field, the method comprising the steps:
(a) receiving by the computing unit (120) soil-related data relating to the sub-field zone (G1), wherein the soil-related data are obtained by real-time measurements using a soil sensor (110) and wherein (G1) which is located within the agricultural field,
(b) receiving by the computing unit (120)—from a database (130) and/or from real-time measurements—crop-related data, field-related data, and optionally weather-related data relating to the sub-field zone (G1),
(c) determining via a computing unit (120)—based on the soil-related data, crop-related data, field-related data and optionally weather-related data—at least one indicator indicative of the crop protection demand and/or crop nutrition demand relating to the sub-field zone (G1),
(d) dynamically generating via the computing unit (120), an output signal (140) dependent from the determined at least one indicator, wherein the output signal (140) is generated during real-time operation of the agricultural treatment device (200) and is usable for controlling the agricultural treatment device (200) at the sub-field zone (G1).

In view of the above object(s) of the present invention, the present invention also relates to a computer-implemented method for treatment of an agricultural field, the method comprising the steps:
(a) receiving by the computing unit (120) soil-related data relating to the sub-field zone (G1), wherein the soil-related data are obtained by real-time measurements using a soil sensor (110) and wherein (G1) which is located within the agricultural field,
(b) receiving by the computing unit (120)—from a database (130) and/or from real-time measurements—crop-related data, field-related data, and weather-related data relating to the sub-field zone (G1),
(c) determining via a computing unit (120)—based on the soil-related data, crop-related data, field-related data and weather-related data—at least one indicator indicative of the crop protection demand and/or crop nutrition demand relating to the sub-field zone (G1),
(d) dynamically generating via the computing unit (120), an output signal (140) dependent from the determined at least one indicator, wherein the output signal (140) is generated during real-time operation of the agricultural treatment device (200) and is usable for controlling the agricultural treatment device (200) at the sub-field zone (G1).

In view of the above object(s) of the present invention, the present invention also relates to an agricultural treatment device (200) comprising:
at least one soil sensor (110) which is operatively coupled or mechanically attached to the agricultural treatment device (200) and which is configured to obtain soil-related data relating to a sub-field zone (G1) through real-time measurements,
at least one computing unit (120) configured to receive soil-related data, crop-related data, field-related data and optionally weather-related data relating to the sub-field zone (G1) obtained from database (130) and/or from real-time measurements, wherein the computing unit (120) is further configured to determine—based on the soil-related data, crop-related data, field-related data and optionally weather-related data—at least one indicator indicative of the crop protection demand and/or crop nutrition demand relating to the sub-field zone (G1), and
wherein the computing unit (120) is further configured to dynamically generate an output signal (140) dependent from the determined at least one indicator, wherein the output signal (140) is generated during real-time operation of the agricultural treatment device (200) and is usable for controlling the agricultural treatment device (200) at the sub-field zone (G1).

In view of the above object(s) of the present invention, the present invention also relates to an agricultural treatment device (200) comprising:
at least one soil sensor (110) which is operatively coupled or mechanically attached to the agricultural treatment device (200) and which is configured to obtain soil-related data relating to a sub-field zone (G1) through real-time measurements,
at least one computing unit (120) configured to receive soil-related data, crop-related data, field-related data and weather-related data relating to the sub-field zone (G1) obtained from database (130) and/or from real-time measurements, wherein the computing unit (120) is further configured to determine—based on the soil-related data, crop-related data, field-related data and weather-related data—at least one indicator indicative of the crop protection demand and/or crop nutrition demand relating to the sub-field zone (G1), and
wherein the computing unit (120) is further configured to dynamically generate an output signal (140) dependent from the determined at least one indicator, wherein the output signal (140) is generated during real-time operation of the agricultural treatment device (200) and is usable for controlling the agricultural treatment device (200) at the sub-field zone (G1).

The term “treatment” or “treatment of an agricultural field”, as used herein, preferably comprises:
protecting a crop or plant, which is cultivated or is to be cultivated on an agricultural field, via destroying a weed that is not cultivated and may be harmful for the crop, in particular with a herbicide, via controlling or killing insects or animal pests on the crop and/or the weed, in particular with an insecticide, nematicide, acaricide, molluscicide, and/or rodenticide, and via controlling or destroying any pathogens and/or plant diseases on the crop, in particular with a fungicide, and/or
regulating the growth of crop or plants on an agricultural field, in particular with a plant growth regulator, and/or
seeding, i.e. spreading or planting the seeds or seedlings of the crops or plants to be cultivated on an agricultural field, and/or
providing fertilizers or nutrients to the crop or plant which is cultivated or is to be cultivated on an agricultural field, and/or
irrigation of an agricultural field.

The term “agricultural treatment device” or “treatment device”, as used herein or also called control technology, may comprise chemical control technology, or seed control technology, or irrigation control technology. Chemical control technology preferably comprises at least one means for application of treatment products, particularly crop protection products like insecticides and/or herbicides and/or fungicides. Such means may include a treatment arrangement (270) comprising one or more spray guns or spray nozzles arranged on an agricultural machine, drone or robot for maneuvering through the agricultural field. Seed control technology preferably comprises at least one means for application of seeds, including equipment for seed broadcasting, dibbing, seed dropping behind the plough, drilling, hill dropping, check rowing and transplanting. For example, seed control technology may include a regular drill planter, in which for instance the seeds are picked from the hopper by a specific circular-shaped plate and released in the shank to be delivered through gravity to the bottom of the furrow.

The term “efficiency” relates to balance of the amount of treatment product applied and the amount of treatment product needed to effectively treat the crops or plants on the agricultural field. How efficiently a treatment is conducted depends on environmental factors such as weather and soil.

The term “efficacy” relates to the balance of positive and negative effects of a treatment product. In other words, efficacy relates to the optimal dose of treatment product needed to effectively treat a specific crop or plant on an agricultural field. The dose should not be so high that treatment product is wasted, which would also increase the costs and the negative impact on the environment, but is not so low that the treatment product is not effectively treated, which could lead to immunization of the crop or plant against the treatment product. Efficacy of a treatment product also depends on environmental factors such as weather and soil.

The term “crop protection product”, as used herein, refers to products for treatment of an agricultural field such as water (used for irrigation), herbicides, insecticides, fungicides, plant growth regulators, nutrition products and/or mixtures thereof. The treatment product may comprise different components—including different active ingredients—such as different herbicides, different fungicides, different insecticide, different nutrition products, different nutrients, as well as further components such as safeners (particularly used in combination with herbicides), adjuvants, fertilizers, co-formulants, stabilizers and/or mixtures thereof. The term “treatment product composition” thereby relates to different active ingredient(s) contained in the treatment product, particularly, the treatment product composition is a composition comprising one, or two, or more treatment products. Thus, there are different types of e.g. herbicides, insecticides and/or fungicides, respectively based on different active ingredient(s). Since the plant to be protected by the treatment product preferably is a crop, the treatment product can be referred to as crop protection product. The treatment product composition may also comprise additional substances that are mixed to the treatment product, like for example water, in particular for diluting and/or thinning the treatment product, and/or a nutrient solution, in particular for enhancing the efficacy of the treatment product. Preferably, the nutrient solution is a nitrogen-containing solution, for example liquid urea ammonium nitrate (UAN).

The term “insecticide”, as used herein, also encompasses nematicides, acaricides, molluscicides, and rodenticides.

The term “nutrition product”, as used herein, refers to any products which are beneficial for the plant nutrition and/or plant health, including but not limited to fertilizers, macronutrients and micronutrients.

The term “crop protection demand”, as used herein, refers to any demand for “crop protection products”.

The term “crop nutrition demand”, as used herein, refers to any demand for “nutrition products”.

The sub-field zone is any partial zone of an agricultural field. For example, the sub-field zone has a size of 200 m×200 m, 100 m×100 m, 50 m×50 m, 30 m×30 m, 20 m×20 m, 10 m×10 m, 5 m×5 m, 3 m×3 m or 1 m×1 m.

### PREFERRED EMBODIMENTS

According to a preferred embodiment of the present invention, real-time measurements in step (b) can be real-time measurements via remote sensing, satellite imagery, drone imagery etc. According to a preferred embodiment of the present invention, the soil-related data comprises:
biological information such as information regarding the microbial activity of the soil, and/or
physical information such as information regarding the soil texture, soil conductivity, soil moisture, soil density, and/or soil temperature, and/or
chemical information such as information regarding the nutrient content of the soil, humus content of the soil, carbonate content of the soil, chemical composition of the soil, soil salinity, and/or pH value of the soil.

According to a preferred embodiment of the present invention, the soil-related data are at least one type of the following data: dry matter, total carbon content, organic carbon content, boron content, phosphorus content, potassium content, nitrogen content, sulfur content, calcium content, iron content, aluminum content, chlorine content, molybdenum content, magnesium content, nickel content, copper content, zinc content, and/or Manganese content, and/or pH value of the soil.

According to a preferred embodiment of the present invention, soil-related data are at least one type of the following data: phosphorus content, potassium content, nitrogen content, sulfur content, calcium content.

According to a preferred embodiment of the present invention, the soil-related data comprises information regarding the soil moisture.

According to a preferred embodiment of the present invention, the soil-related data is the N-total value (also referred to as Nₜₒₜₐₗ value) and/or the at least one indicator is the N-min value (also referred to as Nₘᵢₙ value).

According to a preferred embodiment of the present invention, the crop-related data are at least one type of the following data: species of the planted or to-be-planted crop or seed, yield potential of the planted or to-be-planted crop or seed, genetical information of the planted or to-be-planted crop or seed, protein content of the planted or to-be-planted crop or seed, oil content of the planted or to-be-planted crop or seed, and/or nutrient content of the planted or to-be-planted crop or seed.

According to a preferred embodiment of the present invention, the field-related data are at least one type of the following data: historic yield potential relating to the agricultural field or to the sub-field zone (G1), data regarding the application of crop protection or crop nutrition products on the agricultural field or on the sub-field zone in the past, data regarding the pre-season treatment of the soil (for example regarding tillage or ploughing), data regarding the type of cultivation of the sub-field zone.

According to a preferred embodiment of the present invention, the weather-related data (which are optional) are at least one type of the following data: temperature data, humidity data, wind speed data, precipitation data.

According to a preferred embodiment of the present invention, the weather-related data (which are optional) are soil moisture data not obtained by soil sensor, for example soil moisture data obtained by satellite imagery or remote sensing.

According to a preferred embodiment of the present invention, the output signal (140) is further processed, by the computing unit, to control the agricultural treatment device (200) in such a way that it applies a specific quantity of a crop protection product to the sub-field zone (G1), and wherein the crop protection product is preferably a fertilizer, herbicide, fungicide, insecticide, nematicide, acaricide, molluscicide, rodenticide, biocide, safener, plant health regulator (PGR), nitrification inhibitor, denitrification inhibitor, urease inhibitor, or a combination thereof.

According to a preferred embodiment of the present invention, the output signal (140) is further processed, by the computing unit, to control the agricultural treatment device (200) in such a way that it applies a specific quantity of a fertilizer to the sub-field zone (G1).

According to a preferred embodiment of the present invention, the agricultural treatment device (200) is a crop protection product application device, a fertilizer application device, a seeding device, a planting device, a sowing device, a precision application machine for in-furrow application, more preferably a fertilizer application device.

According to a preferred embodiment of the present invention, the soil sensor (110) is a near-infrared sensor, a gamma radiation sensor, an electrical conductivity sensor, a thermometer, an optical camera, or any combination of the above.

According to a preferred embodiment of the present invention, the soil sensor (110) is a near-infrared sensor

According to a preferred embodiment of the present invention, the soil sensor (110) is operatively coupled to the agricultural treatment device (200), for example in a way that there is a data connection or a possibility of communication between the soil sensor (110) and the agricultural treatment device (200).

According to a preferred embodiment of the present invention, the method comprises the following additional step:
(b2) receiving by the computing unit (120)—from a database and/or from real-time measurements—regulatory-related data relating to the crop protection product, preferably regulatory-related data containing the maximum allowable dose rate of the crop protection product.

According to a preferred embodiment of the present invention, the soil sensor is a near-infrared sensor mechanically attached to the agricultural treatment device (200), and the output signal (140) is further processed, by the computing unit, to control the agricultural treatment device (200) in such a way that it applies a specific quantity of a crop protection product to the sub-field zone (G1), and wherein the crop protection product is preferably a fertilizer, herbicide, fungicide, insecticide, nematicide, acaricide, molluscicide, rodenticide, biocide, safener, plant health regulator (PGR), nitrification inhibitor, denitrification inhibitor, urease inhibitor, or a combination thereof.

According to a preferred embodiment of the present invention, the soil sensor is a near-infrared sensor mechanically attached to the agricultural treatment device (200), and the output signal (140) is further processed, by the computing unit, to control the agricultural treatment device (200) in such a way that it applies a specific quantity of a fertilizer to the sub-field zone (G1).

According to a preferred embodiment of the present invention, the soil sensor is a near-infrared sensor mechanically attached to the agricultural treatment device (200), and the output signal (140) is further processed, by the computing unit, to control the agricultural treatment device (200) in such a way that it applies a specific quantity of a fertilizer to the sub-field zone (G1), and the soil-related data is the N-total value and/or the at least one indicator is the N-min value.

According to a preferred embodiment of the present invention, the soil sensor is a near-infrared sensor mechanically attached to the agricultural treatment device (200), and the output signal (140) is further processed, by the computing unit, to control the agricultural treatment device (200) in such a way that it applies a specific quantity of a fertilizer to the sub-field zone (G1), and the soil-related data is the N-total value and the at least one indicator is the N-min value.

According to a preferred embodiment of the present invention (Embodiment 3), the physical distance between the soil sensor (110) and the soil is less than 100 cm, more preferably less than 60 cm, most preferably less than 30 cm, particularly preferably less than 10 cm, particularly more preferably less than 3 cm, particularly most preferably less than 1 cm, particularly less than 5 mm, for example less than 1 mm at the time of obtaining soil-related data in the agricultural field.

According to a preferred embodiment of the present invention, the soil sensor is a non-optical spectrometer, an optical spectrometer, an infrared spectrometer, a near-infrared sensor, an electric conductivity sensor, a magnetic susceptibility (EM) sensor, a gamma-ray sensor, or a photoconductive-layer-containing optical sensor. According to another preferred embodiment of the present invention, the soil sensor is an infrared spectrometer, or a photoconductive-layer-containing optical sensor. According to another preferred embodiment of the present invention, the soil sensor is a photoconductive-layer-containing optical sensor.

The photoconductive-layer-containing optical sensor is preferably a sensor described in the patent application WO2018/019921. The photoconductive-layer-containing optical sensor is more preferably an optical sensor, comprising a layer of at least one photoconductive material, at least two individual electrical contacts contacting the layer of the photoconductive material, and a cover layer deposited on the photoconductive material, wherein the cover layer is an amorphous layer comprising at least one metal-containing compound. The photoconductive-layer-containing optical sensor is most preferably an optical sensor, comprising a layer of at least one photoconductive material, at least two individual electrical contacts contacting the layer of the photoconductive material, and a cover layer deposited on the photoconductive material, wherein the cover layer is an amorphous layer comprising at least one metal-containing compound, wherein the at least one metal-containing compound comprises a metal selected from the group consisting of Al, Ti, Ta, Mn, Mo, Zr, Hf and W. The photoconductive-layer-containing optical sensor is even more preferably an optical sensor, comprising a layer of at least one photoconductive material, at least two individual electrical contacts contacting the layer of the photoconductive material, and a cover layer deposited on the photoconductive material, wherein the cover layer is an amorphous layer comprising at least one metal-containing compound, wherein the photoconductive material comprises at least one chalcogenide, wherein the chalcogenide is selected from the group consisting of lead sulfide (PbS), copper indium sulfide (CIS), copper indium gallium selenide (CIGS), copper zinc tin sulfide (CZTS), lead selenide (PbSe), copper zinc tin selenide (CZTSe), cadmium telluride (CdTe), mercury cadmium telluride (HgCdTe), mercury zinc telluride (HgZnTe), lead sulfoselenide (PbSSe), copper-zinc-tin sulfur-selenium chalcogenide (CZTSSe), and a solid solution and/or a doped variant thereof. The photoconductive-layer-containing optical sensor has preferably a compact design, a high wavelength resolution (e.g. below 50 nm, e.g. preferably below 30 nm, e.g. preferably below 20 nm), and the wavelength range in which it is operating is preferably between 1 μm and 3 μm, more preferably between 1.2 and 2.6 μm.

According to a preferred embodiment of the present invention, the computing unit (120) can be
mechanically attached to the soil sensor (110), or
mechanically attached to the agricultural treatment device (200), or
mechanically attached to the soil sensor (110) and to the agricultural treatment device (200),
located on another computing resource communicatively coupled to the soil sensor (110), or
located on another computing resource communicatively coupled to the agricultural treatment device (200), or
located on another computing resource communicatively coupled to the soil sensor (110) and to the agricultural treatment device (200).

The following reference list is used in the present application.

### REFERENCE LIST

110 soil sensor
120 computing unit
130 database
140 output signal
200 agricultural treatment device
270 treatment arrangement
G1 sub-field zone

The above mentioned and other aspects of the invention will be apparent from and elucidated further with reference to the embodiments described by way of examples in the following description and with reference to the accompanying drawings, in which

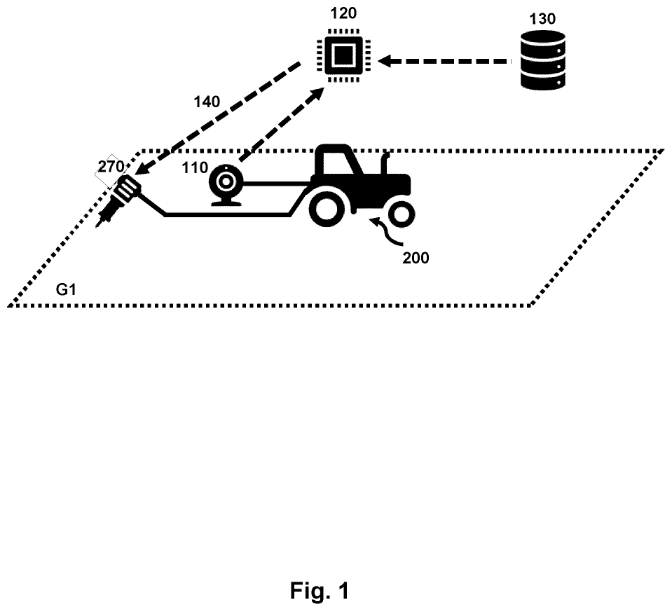

FIG. 1 illustrates the method of the present invention on an example of an agricultural treatment device (200) comprising a mechanically attached soil sensor (110) and a mechanically attached treatment arrangement (270).

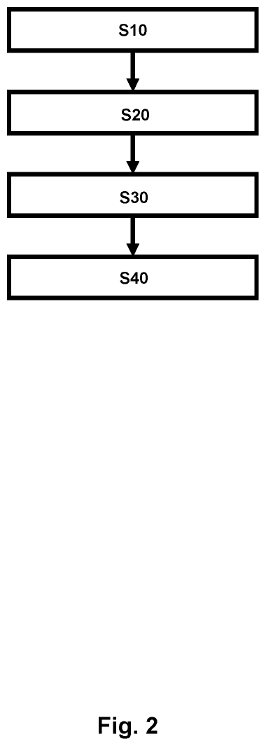

FIG. 2 illustrates a flow diagram showing the operation of the method of the present invention.

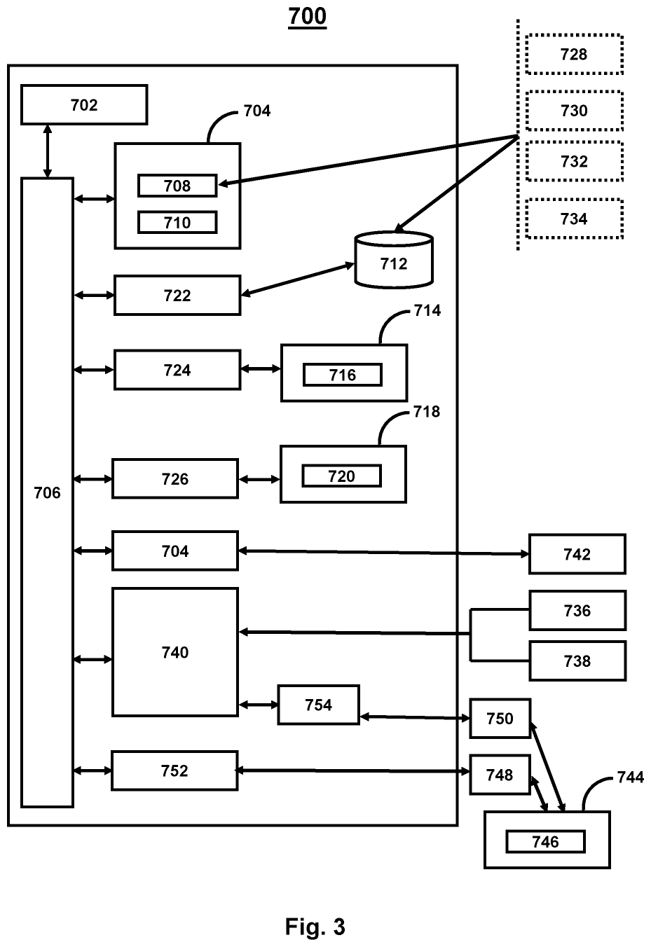

FIG. 3 illustrates an embodiment of an exemplary computing architecture 700 suitable for implementing various embodiments as previously described.

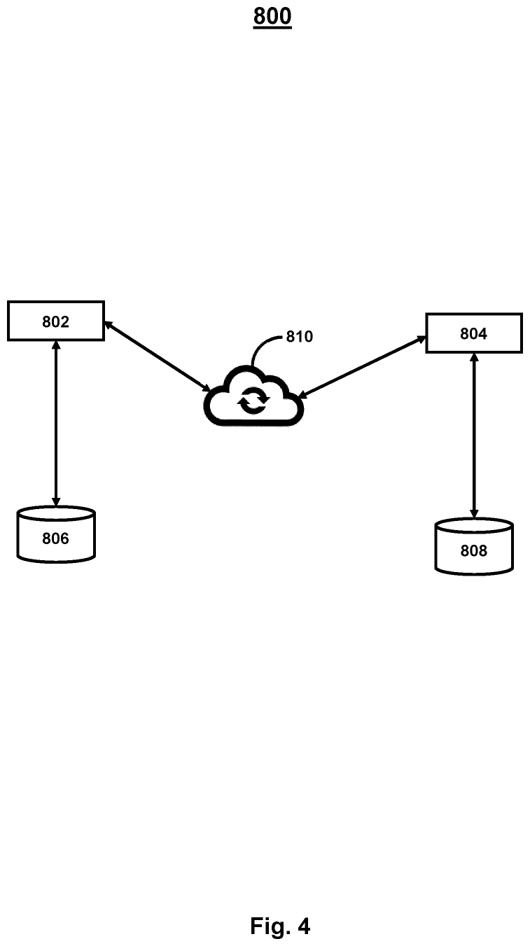

FIG. 4 is a block diagram depicting an exemplary communications architecture 800 suitable for implementing various embodiments as previously described.

It should be noted that the figures are purely diagrammatic and not drawn to scale. In the figures, elements which correspond to elements already described may have the same reference numerals. Examples, embodiments or optional features, whether indicated as non-limiting or not, are not to be understood as limiting the invention as claimed.

### DETAILED DESCRIPTION OF THE DRAWINGS

FIG. 1 illustrates the method of the present invention on an example of an agricultural treatment device (200) comprising
a soil sensor (110) which is mechanically attached to the agricultural treatment device (200),
a treatment arrangement (270) which is mechanically attached to the agricultural treatment device (200).

The computing unit (120) which can be either mechanically attached to the soil sensor (110) and/or to the agricultural treatment device (200) or is located on another computing resource communicatively coupled to the soil sensor (110) and/or to the agricultural treatment device (200), receives real-time soil-related data—e.g. the nitrogen content of the soil—relating to the sub-field zone (G1) from the soil sensor (110) as well as further data (crop-related data, field-related data and optionally weather-related data) relating to the sub-field zone (G1) from the database (130). Based on the received data (soil-related data, crop-related data, field-related data and optionally weather-related data), the computing unit (120) first determines one indicator indicative of the crop protection demand and/or crop nutrition demand relating to the sub-field zone (G1). Then, the computing unit (120) dynamically generates an output signal (140) dependent from the determined at least one indicator, wherein the output signal (140) is generated during real-time operation of the agricultural treatment device (200) and is usable for controlling the agricultural treatment device (200), particularly its treatment arrangement (270), at the sub-field zone (G1).

FIG. 2 illustrates a flow diagram showing the operation of the method of the present invention. In step (S10), the computing unit (120) receives soil-related data relating to the sub-field zone (G1), wherein the soil-related data are obtained by real-time measurements using a soil sensor (110) and wherein (G1) which is located within the agricultural field. In step (S20), the computing unit (120) receives—from a database (130) and/or from real-time measurements—crop-related data, field-related data, and optionally weather-related data relating to the sub-field zone (G1). In step (S30), the computing unit (120) determines—based on the soil-related data, crop-related data, field-related data and optionally weather-related data—at least one indicator indicative of the crop protection demand and/or crop nutrition demand relating to the sub-field zone (G1). In step (S40), the computing unit (120) dynamically generates an output signal (140) dependent from the determined at least one indicator, wherein the output signal (140) is generated during real-time operation of the agricultural treatment device (200) and is usable for controlling the agricultural treatment device (200) at the sub-field zone (G1).

The above-described methods may be embodied as instructions on a computer readable medium or as part of a computing architecture, particularly part of the computing architecture 700 as illustrated in FIG. 3. The soil sensor (110), the computing unit (120), the database (130), the agricultural treatment device (200), or the treatment arrangement (270) may be embodied as part of a computing architecture, particularly part of the computing architecture 700 as illustrated in FIG. 3.

FIG. 3 illustrates an embodiment of an exemplary computing architecture 700 suitable for implementing various embodiments as previously described. In one embodiment, the computing architecture 700 may comprise or be implemented as part of an electronic device, such as a computer 701. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 3, the computing architecture 700 comprises a computer processing unit 702, a system memory 704 and a system bus 706. The computer processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi processor architectures may also be employed as the computer processing unit 702.

The system bus 706 provides an interface for system components including, but not limited to, the system memory 704 to the computer processing unit 702. The system bus 706 can be any of several types of bus structure that may further interconnect to a memory bus (with or without a memory controller), a peripheral bus, and a local bus using any of a variety of commercially available bus architectures. Interface adapters may connect to the system bus 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or nonremovable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a nontransitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 3, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 694 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components of the #soil sensor (110), computing unit (120), the database (130), the agricultural treatment device (200), or the treatment arrangement (270).

A user can enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the computer processing unit 702 through an input device interface 740 that is coupled to the system bus 706, but can be connected by other interfaces such as a parallel port, IEEE 694 serial port, a game port, a USB port, an IR interface, and so forth.

A monitor 742 or other type of display device is also connected to the system bus 706 via an interface, such as a video adaptor. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many or all of the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all of which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the system bus 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

FIG. 4 is a block diagram depicting an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 4, the communications architecture 800 includes one or more clients 802 and servers 804. The clients 802 and the servers 804 are operatively connected to one or more respective client data stores 806 and server data stores 808 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.8a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the methods or computer-implemented methods described herein.

1. A computer-implemented method for controlling an agricultural treatment device (200) in an agricultural field, the method comprising:
(a) receiving by a computing unit (120) soil-related data relating to a sub-field zone (G1), wherein the soil-related data are obtained by real-time measurements using a soil sensor (110) and wherein (G1) which is located within the agricultural field;
(b) receiving by the computing unit (120)—from a database (130) and/or from real-time measurements—crop-related data, field-related data, and optionally weather-related data relating to the sub-field zone (G1);
(c) determining via a computing unit (120), based on the soil-related data, crop-related data, field-related data and optionally weather-related data, at least one indicator indicative of crop protection demand and/or crop nutrition demand relating to the sub-field zone (G1); and
(d) dynamically generating via the computing unit (120), an output signal (140) dependent from the determined at least one indicator, wherein the output signal (140) is generated during real-time operation of the agricultural treatment device (200) and is usable for controlling the agricultural treatment device (200) at the sub-field zone (G1).

2. The method of claim 1, wherein the soil-related data are indicative of the biological, biochemical, chemical, and/or physical properties of the soil.

3. The method of claim 1, wherein the soil-related data are at least one type of the following data: dry matter, total carbon content, organic carbon content, boron content, phosphorus content, potassium content, nitrogen content, sulfur content, calcium content, iron content, aluminum content, chlorine content, molybdenum content, magnesium content, nickel content, copper content, zinc content, and/or Manganese content, and/or pH value of the soil.

4. The method of claim 1, wherein the soil-related data is the N-total value and/or the at least one indicator is the N-min value.

5. The method of claim 1, wherein the crop-related data are at least one type of the following data: species of the planted or to-be-planted crop or seed, yield potential of the planted or to-be-planted crop or seed, genetical information of the planted or to-be-planted crop or seed, protein content of the planted or to-be-planted crop or seed, oil content of the planted or to-be-planted crop or seed, and/or nutrient content of the planted or to-be-planted crop or seed.

6. The method of claim 1, wherein the field-related data are at least one type of the following data: historic yield potential relating to the agricultural field or to the sub-field zone (G1), data regarding the application of crop protection or crop nutrition products on the agricultural field or on the sub-field zone in the past, data regarding the pre-season treatment of the soil, data regarding the type of cultivation of the sub-field zone.

7. The method of claim 1, wherein the weather-related data are at least one type of the following data: temperature data, humidity data, wind speed data, precipitation data.

8. The method of claim 1, wherein the output signal (140) is further processed, by the computing unit, to control the agricultural treatment device (200) in such a way that it applies a specific quantity of a crop protection product to the sub-field zone (G1), and wherein the crop protection product is a fertilizer, herbicide, fungicide, insecticide, nematicide, acaricide, molluscicide, rodenticide, biocide, safener, plant health regulator (PGR), nitrification inhibitor, denitrification inhibitor, urease inhibitor, or a combination thereof.

9. The method of claim 1, wherein the output signal (140) is further processed, by the computing unit, to control the agricultural treatment device (200) in such a way that it applies a specific quantity of a fertilizer to the sub-field zone (G1).

10. The method of claim 1, wherein the agricultural treatment device (200) is crop protection product application device, a fertilizer application device, a seeding device, a planting device, a sowing device, a precision application machine for in-furrow application.

11. The method of claim 1, wherein the soil sensor (110) is a near-infrared sensor, a gamma radiation sensor, an electrical conductivity sensor, a thermometer, an optical camera, or any combination of the above.

12. The method of claim 1, wherein the soil sensor (110) is a near-infrared sensor.

13. The method of claim 1, wherein the soil sensor (110) is operatively coupled to the agricultural treatment device (200).

14. The method of claim 1, wherein the soil sensor (110) is mechanically attached to the agricultural treatment device (200).

15. The method of claim 14, further comprising:
(b2) receiving by the computing unit (120), from a database (130) and/or from real-time measurements, regulatory-related data relating to the crop protection product.

16. The method of claim 1, wherein:
the soil sensor is a near-infrared sensor mechanically attached to the agricultural treatment device (200), and
the output signal (140) is further processed, by the computing unit, to control the agricultural treatment device (200) in such a way that it applies a specific quantity of a crop protection product to the sub-field zone (G1), and wherein the crop protection product is a fertilizer, herbicide, fungicide, insecticide, nematicide, acaricide, molluscicide, rodenticide, biocide, safener, plant health regulator (PGR), nitrification inhibitor, denitrification inhibitor, urease inhibitor, or a combination thereof.

17. The method of claim 1, wherein:
the soil sensor is a near-infrared sensor mechanically attached to the agricultural treatment device (200), and
the output signal (140) is further processed, by the computing unit, to control the agricultural treatment device (200) in such a way that it applies a specific quantity of a fertilizer to the sub-field zone (G1).

18. The method of claim 1, wherein:
the soil sensor is a near-infrared sensor mechanically attached to the agricultural treatment device (200), and
the output signal (140) is further processed, by the computing unit, to control the agricultural treatment device (200) in such a way that it applies a specific quantity of a fertilizer to the sub-field zone (G1), and
the soil-related data is the N-total value and/or the at least one indicator is the N-min value.

19. An agricultural treatment device (200) comprising:
at least one soil sensor (110) which is operatively coupled or mechanically attached to the agricultural treatment device (200) and which is configured to obtain soil-related data relating to a sub-field zone (G1) through real-time measurements; and
at least one computing unit (120) configured to receive soil-related data, crop-related data, field-related data and optionally weather-related data relating to the sub-field zone (G1) obtained from database (130) and/or from real-time measurements,
wherein the computing unit (120) is further configured to determine—based on the soil-related data, crop-related data, field-related data and optionally weather-related data—at least one indicator indicative of crop protection demand and/or crop nutrition demand relating to the sub-field zone (G1), and
wherein the computing unit (120) is further configured to dynamically generate an output signal (140) dependent from the determined at least one indicator, wherein the output signal (140) is generated during real-time operation of the agricultural treatment device (200) and is usable for controlling the agricultural treatment device (200) at the sub-field zone (G1).
